(19) United States
(12) Patent Application Publication
(10) Pub. No.: US 2008/0253540 A1
(43) Pub. Date: Oct. 16, 2008

(54) System And Method For Managing Incoming Communication Based Upon Local Time

(76) Inventor: James Siminoff, Miami Beach, FL (US)

Correspondence Address: LATHROP & GAGE LC, 4845 PEARL EAST CIRCLE, SUITE 300, BOULDER, CO, 80301, US

(21) Appl. No.: 12/052,474

(22) Filed: Mar. 20, 2008

Related U.S. Application Data
(60) Provisional application No. 60/895,903, filed on Mar. 20, 2007.

(51) Int. Cl. H04M 1/56

(52) U.S. Cl. 379/142.11

(57) ABSTRACT

A system and method manage incoming communications to a communication device. An incoming communication is received for the communication device and a local time of the communication device is determined. The incoming communication is intercepted if the local time is within a restricted operating period of the communication device and the incoming communication is allowed if the local time falls outside of the restricted operating period. If the incoming communication is a call, the call may be answered to determine if it is urgent. A code may be used within a non-call communication to indicate that it is urgent. Communications deemed urgent are allowed to the communication device.

### RELATED APPLICATIONS

This application claims priority to U.S. Provisional Application Ser. No. 60/895,903, filed Mar. 20, 2007, which is incorporated herein by reference.

### BACKGROUND

A communication subscriber typically controls incoming calls by selectively turning a communication device on and off, or by turning the audio output device (e.g., ringer) on and off. However, to generally be operable to receive incoming calls, the communication device must be on, with audio output on. An incoming call to the subscriber is typically routed directly to the communication device from the service provider. That is, the originating communication device is connected to the destination communication device through the service provider. For example, when a user of the first communication device calls a second communication device, the service provider causes the second communication device to ring. If the user of the second communication device is asleep, for example, they would be awakened, perhaps unnecessarily, especially in the case of an incorrectly dialed number by the user of the first communication device.

Communication devices are not typically turned off, even when the subscriber is asleep, since it is desirable to receive important and/or emergency incoming calls. Still, a cell phone typically includes a button or function that allows the user to configure the phone in silent mode; silent mode may be selected when the user does not want to be disturbed by incoming calls. Silent mode may be selected by pressing a certain button on the cell phone. When receiving a call while operating in silent mode, the cell phone does not audibly signal the operator that there is an incoming call, and thus the call may go unanswered. However, as with other communication devices, the cell phone is typically left on with audio output even at night.

These problems are further exacerbated when the user of the cell phone travels to other time zones. Calls placed from the user's home time zone may result in the user receiving call at inappropriate times (i.e., at night) while traveling in other time zones. For example, there is a time difference of eight hours between San Francisco, Calif. and London, England. A call placed at 5:32 pm local time in San Francisco would awaken a subscriber at 1:32 am local time in London. Such calls may occur, particularly if the caller is unaware that the subscriber is traveling.

### SUMMARY

In an embodiment, a method manages incoming communications to a communication device. An incoming communication is received for the communication device and a local time of the communication device is determined. The incoming communication is intercepted if the local time is within a restricted operating period of the communication device, and the incoming communication is allowed if the local time falls outside of the restricted operating period.

In another embodiment, a system manages an incoming communication to a communication device. A service provider provides communication services to the communication device. A time delta, stored within the service provider, indicates a time difference between a local time of the service provider and a local time of the communication device. Information indicative of a restricted operation period is stored within the service provider, defining a period of restricted operation of the communication device. A communication manager intercepts the incoming communication to the communication device when the local time of the communication device is within the restricted operation period. The communication manager allows the incoming communication to the communication device when the local time of the communication device falls outside of the restricted operation period.

### BRIEF DESCRIPTION OF THE FIGURES

FIG. 1 shows one exemplary system embodiment for managing incoming communications based upon local time.

FIG. 2 shows the service provider of FIG. 1 in further detail.

FIG. 3 is a flowchart illustrating one method for managing incoming calls based upon local time.

FIG. 4 is a flowchart illustrating one exemplary method for updating a time difference between a communication device and a service provider.

FIG. 5 is a flowchart illustrating one method for managing incoming communications based upon local time.

### DETAILED DESCRIPTION OF THE FIGURES

A user of a communication device (e.g., a telephone apparatus) capable of receiving calls from other communication devices may, at certain times, desire to only be disturbed if the call is urgent or an emergency. For example, when the user, or user's household, is asleep, only urgent calls are directed to the communication device to awaken the user to answer the call. Other, non urgent calls are handled by a voicemail device that allows the caller to leave a voice message if desired, thereby not awakening the user unnecessarily. Similarly, other communications, such as short-message-service (SMS) texts, multi-media messaging service (MMS) messages, and e-mails, may also be intercepted to prevent delivery at times when the user does not wish to be disturbed.

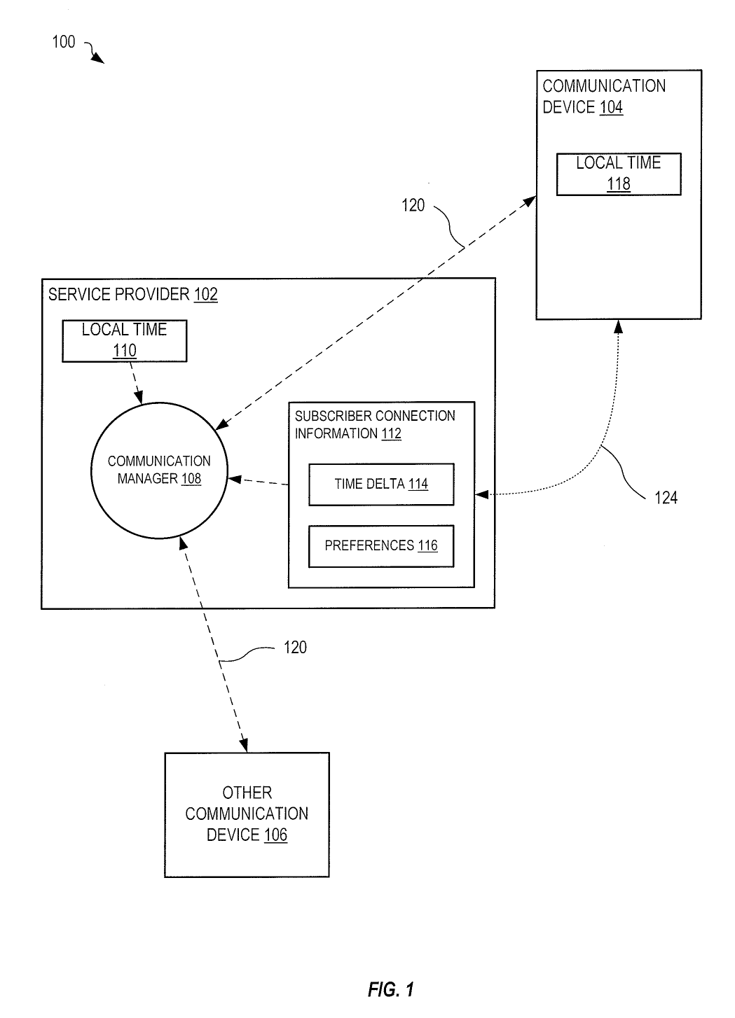

FIG. 1 shows one exemplary system 100 for managing incoming communications based upon local time. System 100 shows a service provider 102 that provides communication services to one or more communication devices, such as a subscriber communication device 104 and other communication device 106. In one example, service provider 102 is a wired communication service provider and communication devices 104, 106 are household/office telephone devices. In another example, service provider 102 is a cell phone service provider and communication devices 104, 106 are cell phones. Service provider 102 may represent one or more other types of communication service providers without departing from the scope hereof. Communication devices 104, 106 may represent other types of communication device (e.g., smart phone, pager, PDA, computer, VoIP device, etc.) without departing from the scope hereof. Other communication device 106 may not be a subscriber of service provider 102; it may instead utilize a second service provider (not shown) to connect to service provider 102.

Service provider 102 maintains a local time 110 that for example represents the local time for a central location of service provider 102. Service provider 102 also includes a communication manager 108 that handles incoming communications (e.g., calls, SMS text messages, MMS messages and e-mails) for its subscribers (e.g., a user/owner of communication device 104). Communication device 104 is also shown with a local time 118 which for example represents the time at the location of communication device 104.

In an embodiment, where communication device 104 remains at one location, local time 118 is provided by service provider 102 based upon subscriber connection information 112 associated with communication device 104. For example, upon subscribing to service with service provider 102, subscriber connection information 112 is entered with a time delta 114 that defines the local time 118 of communication device 104 with respect to local time 110 of service provider 102.

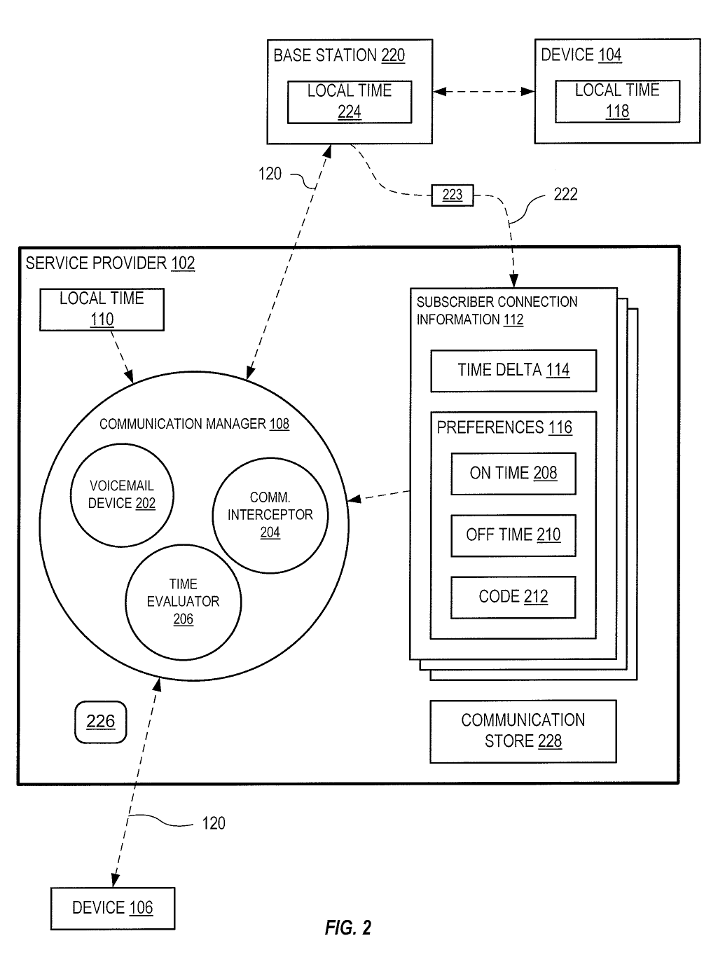

In another embodiment, where communication device is mobile, and connects to service provider 102 via a base station (e.g., base station 220, FIG. 2), communication device 104 may determine local time from the base station (i.e., it determines the local time for the current location of communication device 104) and sends that time, upon connection to that base station, to service provider 102, thereby allowing service provider 102 to update time delta 114 within subscriber connection information 112. Thus, service provider 102 maintains a correct delta time 114 for communication device 104 irrespective of location of communication device 104.

In another embodiment, service provider 102 determines local time of device 104 based upon routing information received from the base station as device 104 connects thereto. For example, routing by service provider 102 is based upon a known connectivity of device 104 to a base station local to device 104. Typically, upon connection of communication device 104 to a base station, the base station sends routing information to service provider 102 such that service provider 102 may route communications to device 104. This routing information may include a local time of the base station, thereby allowing service provider 102 to automatically update time delta 114.

Communication path 124 represents a ‘connection’ between communication device 104 and service provider 102, to allow editing and maintenance of subscriber connection information 112. A user of communication device 104 may set preferences 116 within subscriber connection information 112 to define a time when only urgent communications are permitted to connect to communication device 104, thereby defining a restricted operating period, as well as a time when all communications are permitted to communication device 104 (a normal operating period). In one example, a user of communication device 104 (e.g., the subscriber to service provider 102 of communication device 104) specifies that only urgent communications should be routed to communication device 104 between the hours of 11 pm and 8 am; that is, all communications should be routed to communication device 104 between the hours of 8 am and 11 pm. In one embodiment, communication device 104 facilitates interaction with service provider 102 to maintain connection information 112. In another embodiment, service provider 102 provides for setting of preferences 116 via an Internet connection using a web browser.

In one example of operation, other communication device 106 places a call 120 to (e.g., dials the number of) communication device 104. Communication manager 108 determines the local time of communication device 104, based upon local time 110 and time delta 114, and then determines if normal calls are permitted to communication device 104 based upon preferences 116. If the determined local time of communication device 104 is within the normal operating period of communication device 104, communication manager 108 connects call 120 to communication device 10, thereby causing communication device 104 to ‘ring’. If the determined local time of communication device 104 is within the restricted operating period, communication manager 108 interacts with the user of other communication device 106 to determine (a) if call 120 is urgent, in which case call 120 is connected to communication device 104, or (b) if the user would prefer to leave a message for communication device 104.

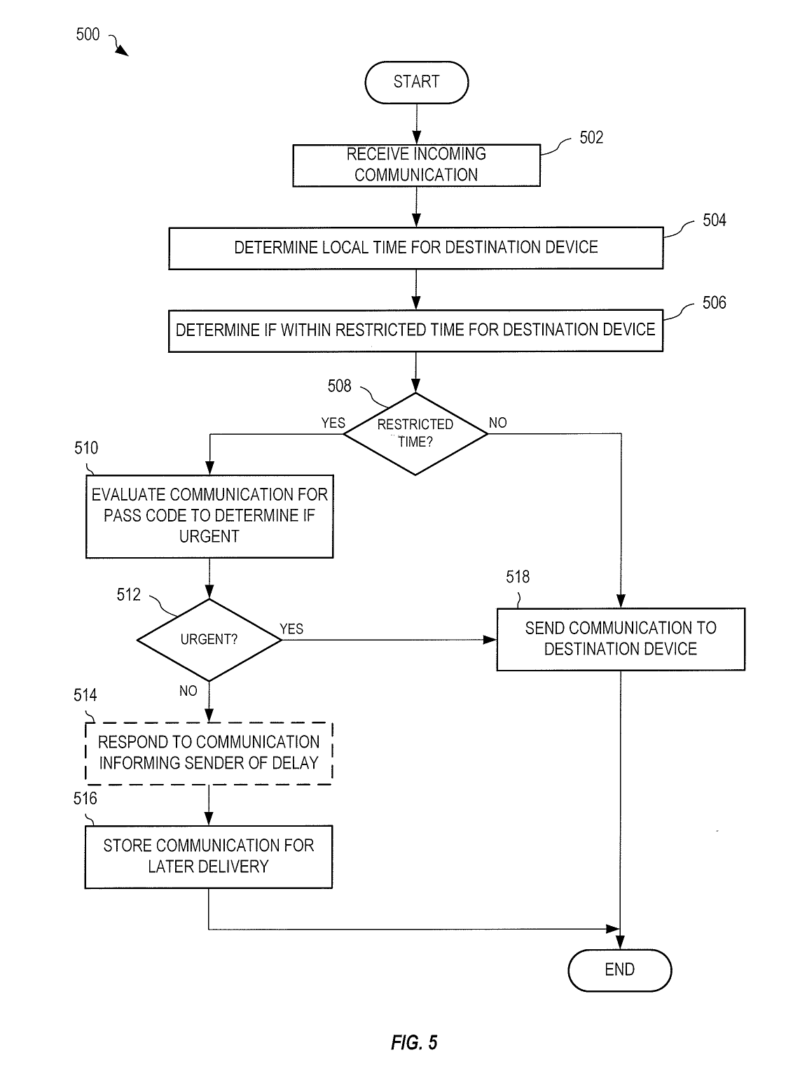

FIG. 2 shows the service provider 102 of FIG. 1 in exemplary further detail. Features of FIG. 2 (i.e., SMS text 226 and communication store 228) are further explained with respect to FIG. 5, below.

Communication manager 108 is shown with a voicemail device 202, a communication interceptor 204 and a time evaluator 206. Communication interceptor 204 utilizes time evaluator 206 to determine the local time of subscriber communication devices when communications (e.g., call 120) are received by service provider 102. Time evaluator 206 utilizes local time 110 and time delta 114 to determine local time 118 for device 104, and communication interceptor 204 then utilizes an on time setting 208 and an off time setting 210 to determine whether the communication (e.g., call 120, an SMS text, an MMS message, an e-mail, etc.) may connect directly to device 104 or whether to intercept the communication and determine if it is urgent. For example, communication interceptor 204 may answer call 120 and play an audio message to inform the caller that calls to the called subscriber are restricted and to present a menu of options available to the caller that include, but are not limited to, one or more of: continuing with the call if it is urgent, leaving a message for the subscriber, and disconnecting. If the caller elects to continue, call 120 connects to device 104; if the caller elects to leave a message, communication interceptor 204 may invoke voicemail device 202 to record a message from the caller such that the subscriber may retrieve the message at a later time; and if the caller elects to disconnect, call 120 is cancelled.

In an embodiment, preferences 116 contain a code 212 that a caller (or communication sender) must enter (or include within the communication) for communication interceptor 204 to determine that the communication is urgent. In one example, code 212 is defined by the subscriber as the character sequence ‘urgent’, thereby requiring the communication initiator (e.g., the sender of the email of TXT message or initiator of call 120) to enter ‘urgent’ within the communication or to enter ‘urgent’ or the numeric keypad equivalent (i.e., ‘874368’) on the keypad of the calling device (e.g., device 106) in response to the audio message played by communication interceptor 204 upon answering call 120. The use of code 212 allows the subscriber to only enable desired communicators (i.e., callers and messages senders) by supplying them with the value of code 212.

In an embodiment, where device 104 is a wireless communication device (e.g., a cell phone or smart phone) that connects to service provider 102 via a base station 220, as device 104 connects to base station 220, routing information 223 is sent via communication 222 to service provider 102 to indicate connectivity and local time of device 104. Routing information 223 may be part of subscriber device tracking data used by service provider 102 to route communications to device 104. Upon receiving routing information 223, time evaluator 206 determines a time difference between local time 1 10 and a local time 224 of base station 220 and updates time delta 114 with this time difference, thereby maintaining time delta 114 for device 104 as and when device 104 moves to other locations (i.e., as device 104 connects to other base stations). For example, if service provider 102 is in California, USA, and device 104 is in London, England, time delta 114 is for example +8 hours.

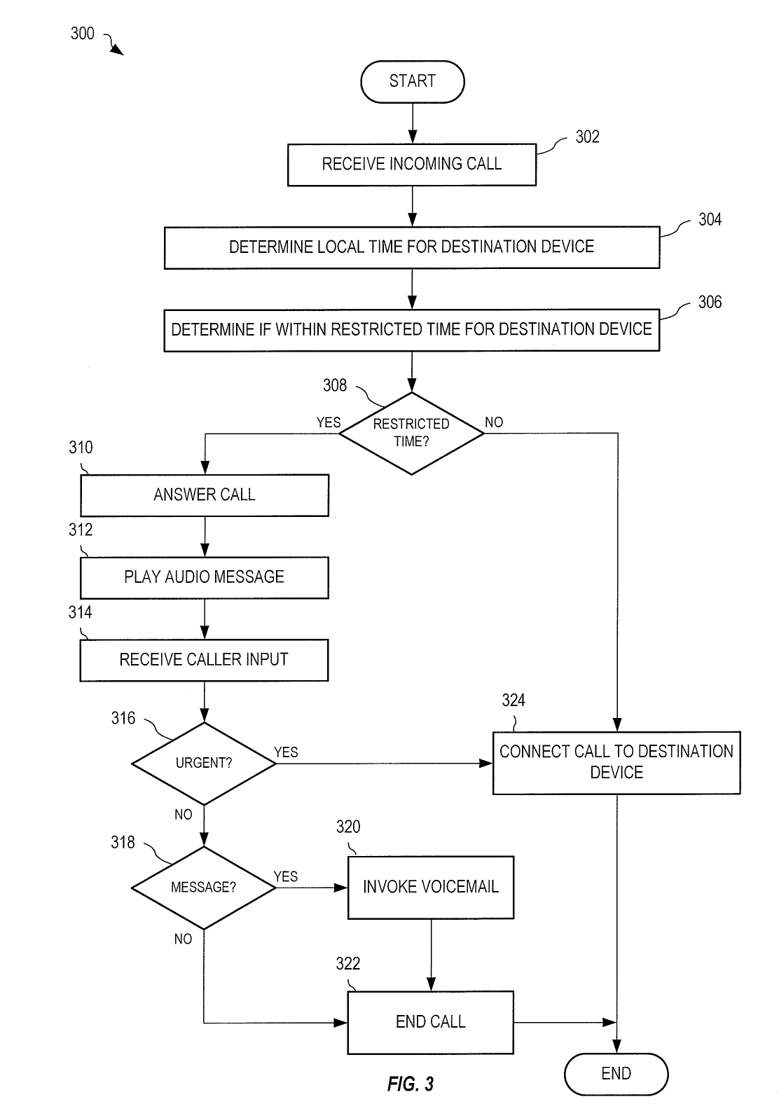

FIG. 3 is a flowchart illustrating one exemplary method 300 for managing incoming calls based upon local time of a destination device (e.g., communication device 104, FIGS. 1 and 2). Method 300 may operate within service provider 102. In step 302, method 300 receives an incoming call for a destination device. In one example of step 302, other communication device 106 places call 120 to communication device 104 via service provider 102. In step 304, method 300 determines the local time for the destination device. In one example of step 304, service provider 102 determines a local time for device 104 based upon time delta 114 and local time 110. In step 306, method 300 determines if the local time of the destination device, determined in step 304, is within the defined restricted time of the destination device. In one example of step 306, communication manager 108 utilizes time evaluator 206 to determine if the determined local time of device 104 is within the restricted time of device 104 based upon ‘on time’ 208 and ‘off time’ 210 within preferences 116.

Step 308 is a decision. If, in step 308, method 300 determines that the local time for the destination device is within its defined restricted time, method 300 continues with step 310; otherwise method 300 continues with step 324. In step 310, method 300 answers the incoming call. In one example of step 310, communication interceptor 204 answers call 120. In step 312, method 300 plays an audio message to the originator of call 120. In one example of step 312, communication interceptor 204 plays a recorded message to device 106, informing the caller that calls to device 104 are restricted and asking the caller if the call is urgent and whether the caller would like to leave a voicemail message if the call is not urgent. In step 314, method 300 receives a response from the caller. In one example of step 314, communication interceptor 204 receives a selection from device 106 indicating that call 120 is urgent. In another example of step 314, communication interceptor 204 receives an urgent code from device 106 for comparison to code 212 within preferences 116 of FIG. 2 to determine if the call is urgent.

Step 316 is a decision. If, in step 316, method 300 determines that the received caller selection indicates that the call to the destination device is urgent, method 300 continues with step 324; otherwise method 300 continues with step 318.

Step 318 is a decision. If, in step 318, method 300 determines that the received selection indicates that the caller would like to leave a voicemail message, method 300 continues with step 320; otherwise method 300 continues with step 322.

In step 320, method 300 invokes voicemail to allow the caller to leave a message for the destination device. In one example of step 320, communication manager 108 invokes voicemail device 202 to record a voicemail message from call 120. Upon termination of the voicemail message from call 120, method 300 continues with step 322. In step 322, method 300 ends the call. In one example of step 322, when the caller has finished leaving the voicemail message, they may hang-up, wherein communication manager 108 disconnects call 120.

In step 324, method 300 connects the call to the destination device. In one example of step 324, communication manager 108 connects call 120 to device 104.

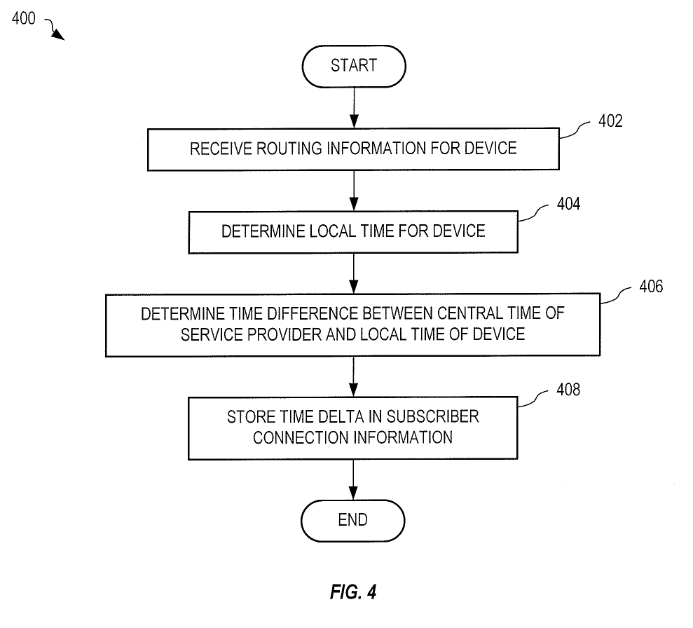

FIG. 4 is a flowchart illustrating one exemplary method for updating a time difference (e.g., time delta 114) between a communication device and a service provider. Method 400 may operate within service provider 102. In step 402, method 400 receives routing information for a communication device. In one example of step 402, service provider 102 receives routing information 223, from base station 220, including local time 224 of base station 220. In step 404, method 400 determines the local time of the communication device. In one example of step 404, service provider 102 determines local time 118 of device 104 from routing information 223. In step 406, method 400 determines a time delta between central time of the service provider and determined local time of the communication device. In one example of step 406, service provider 102 determines the time difference between local time 224, received within routing information 223, and local time 110. In step 408, method 400 stores this time difference in the subscriber connection information for the communication device. In one example of step 408, service provider 102 stores the time difference, determined in step 406, as time delta 114 within subscriber connection information 1 12 that is associated with device 104.

FIG. 5 is a flowchart illustrating one exemplary method 500 for managing incoming communications (e.g., SMS texts, MMS messages, e-mails, etc.) based upon local time of a destination device (e.g., communication device 104, FIGS. 1 and 2). Method 500 may operate within service provider 102. In step 502, method 500 receives an incoming communication for a destination device. In one example of step 502, service provider 102 receives an SMS text 226 (See FIG. 2) from other communication device 106 for communication device 104. In step 504, method 500 determines the local time for the destination device. In one example of step 504, service provider 102 determines a local time for device 104 based upon time delta 114 and local time 110. In step 506, method 500 determines if the local time of the destination device, determined in step 504, is within the defined restricted time of the destination device. In one example of step 506, communication manager 108 utilizes time evaluator 206 to determine if the determined local time of device 104 is within the restricted time of device 104 based upon ‘on time’ 208 and ‘off time’ 210 within preferences 116.

Step 508 is a decision. If, in step 508, method 500 determines that the local time for the destination device is within its defined restricted time, method 500 continues with step 510; otherwise method 500 continues with step 518. In step 510, method 500 evaluates the communication for a pass code to determine if it is urgent. In one example of step 510, communication interceptor 204 processes SMS text 226 to determine if code 212 is included within the text received from other communication device 106; inclusion of the matching code 212 indicates that the communication is urgent.

Step 512 is a decision. If, in step 512, method 500 determines that the communication is urgent, method 500 continues with step 518; otherwise method 500 continues with optional step 514, if included, or step 516 if optional step 514 is not included. If included, in step 514, method 500 responds to the communication informing the sender of the delay in delivery. In one example of step 514, communication interceptor 204 sends an SMS message back to device 106 informing the sender of SMS text 226 that SMS text 226 will not be immediately delivered. In step 516, method 500 stores the communication for later delivery. In one example of step 516, communication interceptor 204 stores SMS text 226 within a communication store 228 (shown in FIG. 2) for delivery during a normal operating period of device 104. Method 500 then terminates.

In step 518, method 500 sends the communication to the destination device. In one example of step 518, communication interceptor 204 sends SMS text 226 to device 104. Method 500 then terminates.

Service provider 102 may also include functionality that allows the user of device 104 to manually request delivery of any waiting communication and/or voicemail during restricted periods. Thus, the user of device 104 may manually request delivery of expected communications without the need to modify connection information 112.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for managing incoming communications to a communication device, comprising:
receiving an incoming communication for the communication device;
determining a local time of the communication device;
intercepting the incoming communication if the local time is within a restricted operating period of the communication device; and
allowing the incoming communication if the local time falls outside of the restricted operating period.

2. The method of claim 1, further comprising:
receiving a first local time for the communication device;
determining a time difference between the first local time and a second local time of a service provider; and
storing the time difference in association with the communication device;
the step of determining the local time of the communication device comprising
calculating the local time based upon the stored time difference and the
second local time of the service provider.

3. The method of claim 1, further comprising determining whether the incoming communication is an incoming call, and wherein intercepting comprises the following steps when the incoming communication is an incoming call:
answering the incoming call;
playing a message to inform the caller of the restricted operating period and asking the caller to indicate if the call is urgent;
receiving, from the caller, an indication as to whether the call is urgent;
connecting the call to the communication device, if the indication signifies that the call is urgent;
prompting the caller to leave a voicemail message if the call is not urgent;
receiving, from the caller, a second indication as to whether the caller wishes to leave a voicemail message; and
recording the voicemail message if the second indication signifies that the caller wishes to leave the voicemail message.

4. The method of claim 3, the indication comprising an input sequence that is compared to a stored code, whereupon a match between the input sequence and the stored code indicate that the incoming call is urgent.

5. The method of claim 1, further comprising determining whether the incoming communication is a call, and wherein intercepting comprises the following steps when the incoming communication is not a call:
processing the incoming communication to determine if the incoming communication is urgent;
sending the incoming communication to the communication device, if the incoming communication is urgent; and
saving the incoming communication if the incoming communication is not urgent.

6. The method of claim 5, the incoming communication comprising one of a short-message-service text message, a multimedia messaging service message, and an e-mail message.

7. The method of claim 5, the step of intercepting further comprising replying to the incoming communication to inform a sender of the incoming communication that there is a delay in delivery of the incoming communication to the communication device.

8. The method of claim 5, the step of processing comprising searching the text of the incoming communication for a code that indicates that the incoming communication is urgent.

9. The method of claim 8, further comprising comparing the code to a stored code associated with the communication device.

10. The method of claim 9, the stored code being configurable by a subscriber associated with the communication device.

11. A system for managing an incoming communication to a communication device, comprising:
a service provider for providing communication services to the communication device;
a time delta, stored within the service provider, indicating a time difference between a local time of the service provider and a local time of the communication device;
information indicative of a restricted operation period, stored within the service provider, defining a period of restricted operation of the communication device;
a communication manager for (a) intercepting the incoming communication to the communication device when the local time of the communication device is within the restricted operation period, (b) allowing the incoming communication to the communication device when the local time of the communication device falls outside of the restricted operation period.

12. The system of claim 11, the communication manager determining the local time of the communication device based upon the time delta and the local time of the service provider.

13. The system of claim 11, the communication manager determining the time delta based upon one or more routing messages of the communication device.

14. The system of claim 11, farther comprising, when the communication is a call, a voicemail device for answering the call to determine whether the call is urgent, the communication manager connecting the call to the communication device if the call is urgent.

15. The system of claim 14, the voicemail device recording a message for delivery to the communication device when the local time of the communication device is not within the restricted operation period, when the call is not urgent.

16. The system of claim 11, further comprising, when the incoming communication is not a call, a communication store for storing the communication until the local time of the communication devices is not within the restricted operation period.

17. The system of claim 11, further comprising a code, stored within the service provider, for use by the communication manager to discern whether the incoming communication is urgent, the communication manager allowing the incoming communication when the local time of the communication device is within the restricted operation period if the incoming communication is urgent.

18. The system of claim 17, wherein, when the incoming communication is not a call, the communication manager processes the incoming communication to determine if the incoming communication is urgent, the incoming communication being urgent if the incoming communication includes the code.

19. The system of claim 17, wherein the code is defined by a subscriber of the communication device.
